(19) United States
(12) Patent Application Publication
(10) Pub. No.: US 2013/0132592 A1
(43) Pub. Date: May 23, 2013

(54) PROVIDING A PLURALITY OF COMMUNICATION CHANNELS FOR USE BY A PROCESSING SYSTEM

(71) Applicant: LEIGH M. ROTHSCHILD, SUNNY ISLES BEACH, FL (US)

(72) Inventor: LEIGH M. ROTHSCHILD, SUNNY ISLES BEACH, FL (US)

(73) Assignee: SAMANTHA INVENTIONS, L.L.C., BAY HARBOUR, FL (US)

(21) Appl. No.: 13/300,211

(22) Filed: Nov. 18, 2011

(51) Int. Cl. G06F 15/16

(52) U.S. Cl. 709/228

(57) ABSTRACT

A method of providing a plurality of communication channels for use by a processing system. The method can include, via a processor, providing to the processing system an option to establish a first communication channel via first communication adapter. The method also can include providing to the processing system an option to establish at least a second communication channel via at least a second communication adapter. Responsive to receiving a request from the processing system to establish both the first communication channel and the second communication channel to be simultaneously active, a transaction notification to apply a fee to an account associated with the processing system can be generated.

### BACKGROUND

One or more embodiments disclosed within this specification relate to wireless communications.

Wired communication links oftentimes are implemented to connect computers and other processing devices to various types of communication networks, for example a wide area network (WAN), such as the Internet. In illustration, a computer (or other processing device) may be communicatively linked to a cable modem or digital subscriber line (DSL) modem which connects the computer to the WAN. The computer may be directly connected to a modem via a communication port, such as a serial communication port, a universal serial bus (USB) port, or connected to the modem via a local area network (LAN) or wireless LAN (WLAN). Leased communication lines (e.g., T1 lines, T3 lines, T10 lines, etc.) also may be used to connect a computer to the WAN. A computer typically is connected to a leased communication line via a LAN or WLAN.

The most commonly used WLANs are those implemented in accordance with the IEEE 802.11 family of communication standards. Wireless fidelity (Wi-Fi™) is an example of an implementation of IEEE 802.11. Wi-Fi is a trademark of the Wi-Fi Alliance, which is a trade association that promotes WLAN technologies and certifies products that conform to certain standards of interoperability. In this regard, not all devices that conform to an applicable IEEE 802.11 standard are Wi-Fi™ certified.

A large number of mobile communication devices, for example, mobile telephones, utilize various cellular communication technologies, such as 2^{nd} Generation Mobile Communications (2G), 3^{rd} Generation Mobile Communications (3G) and 4^{th} Generation Mobile Communications (4G), to connect to WANs. Mobile WiMax is approved as a 3G standard by the International Telecommunications Union (ITU), and sometimes is marketed as a 4G standard. WiMax stands for the Worldwide Interoperability for Microwave Access, and refers to interoperable implementations of the IEEE 802.16 communication standard. Long term evolution (LTE) Advanced also sometimes is branded as a 4G technology.

The transition to 3G wireless communications from older communication technologies, such as 2G, has provided increased bandwidth to consumers, which has help to proliferate the use of smart phones to connect to and browse the Internet. Cellular network infrastructure that supports 4G wireless communications now is being deployed by various cellular communication carriers to further increase the amount of cellular communication bandwidth available to consumers.

### BRIEF SUMMARY

One or more embodiments disclosed within this specification relate to a method of providing a plurality of communication channels for use by a processing system. The method can include, via a processor, providing to the processing system an option to establish a first communication channel via first communication adapter. The method also can include providing to the processing system an option to establish at least a second communication channel via at least a second communication adapter. Responsive to receiving a request from the processing system to establish both the first communication channel and the second communication channel to be simultaneously active, a transaction notification to apply a fee to an account associated with the processing system can be generated.

Another method can include providing a plurality of communication channels for use by a processing system. The method can include receiving an identifier purchased by a user in a commercial transaction. Responsive to receiving the identifier, at least one communication adapter selected from a group consisting of a first communication adapter and a second communication adapter can be at least temporarily enabled.

Another embodiment can include a processing system. The processing system can include a processor configured to perform executable operations and/or functions disclosed within this specification.

Another embodiment can include a server. The server can include a processor configured to perform executable operations and/or functions disclosed within this specification.

Another embodiment can include a computer program product for increasing communication bandwidth for a processing system. The computer program product can include a computer-readable storage medium having computer-readable program code embodied therewith, the computer-readable program code configured to perform the various operations and/or functions disclosed within this specification.

### BRIEF DESCRIPTION OF THE SEVERAL VIEWS OF THE DRAWINGS

FIG. 1 is a block diagram illustrating a communication system in accordance with one embodiment of the present invention.

FIG. 2 is a block diagram illustrating a server in accordance with one embodiment of the present invention.

FIG. 3 is a flow diagram representing exchange of information in accordance with one embodiment of the present invention.

FIG. 4 is a flow diagram representing exchange of information in accordance with another embodiment of the present invention.

FIG. 5 depicts a view of a control panel presented by a graphical user interface in accordance with one embodiment of the present invention.

FIG. 6 depicts a view of a window presented by a graphical user interface in accordance with one embodiment of the present invention.

FIG. 7 depicts a view of another window presented by a graphical user interface in accordance with one embodiment of the present invention.

FIG. 8 depicts a view of another window presented by a graphical user interface in accordance with one embodiment of the present invention.

FIG. 9 is a flow chart illustrating a method of increasing communication bandwidth for a processing in accordance with one embodiment of the present invention.

FIG. 10 is a flow chart illustrating a method of increasing communication bandwidth for a processing in accordance with another embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable storage medium(s) having computer-readable program code embodied, e.g., stored, thereon.

Any combination of one or more computer-readable storage medium(s) may be utilized. The computer-readable storage medium can be non-transitory in nature. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a storage computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments described herein relate to a method and a system for providing a plurality of communication channels for use by a processing system. In illustration, a processing system can communicate with a server over a plurality of communication channels. A transaction notification to apply a fee to an account associated with the processing system can be generated responsive to receiving a request from the processing system to esablish the plurality of communication channels.

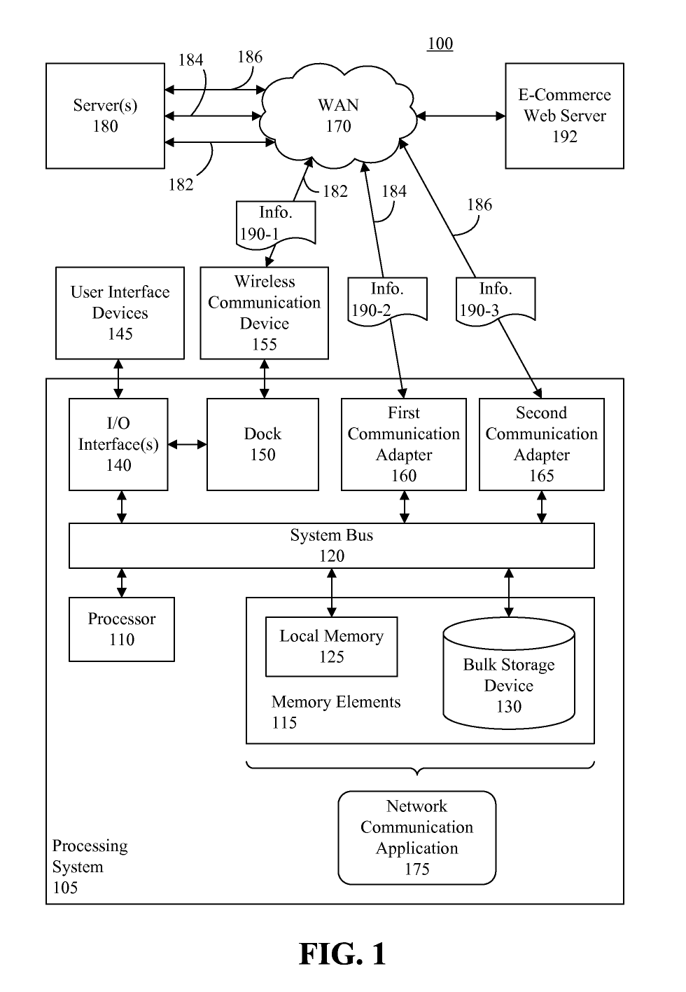

FIG. 1 is a block diagram illustrating a communication system 100 in accordance with one embodiment of the present invention. The communication system 100 can include a processing system 105, which can be a client in the communication system 100. In one aspect, for example, the processing system 105 can be implemented as computer that is suitable for storing and/or executing program code. Examples of a computer can include, but are not limited to, a server, a workstation, a personal computer, a laptop computer, a netbook computer, a tablet computer, and the like. In another aspect, the processing system 105 can be a mobile communication device. Examples of a mobile communication device can include, but are not limited to, a mobile telephone, a smart phone, a personal digital assistant (PDA), and the like. It should be appreciated, however, that the processing system 105 can be implemented in the form of any system comprising a processor and memory that is capable of performing the functions described within this specification, and the invention is not limited to these specific examples.

The processing system 105 can include at least one processor 110 coupled to a system bus 120. The system bus 120 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Via the system bus 120, the processor 110 can be coupled to memory elements 115. As such, the processing system 105 can store computer-readable program code (hereinafter “program code”) within the memory elements 115. The processor 110 can execute the program code accessed from the memory elements 115 via the system bus 120. Moreover, the processor 110 can execute any of a variety of suitable operating systems (not shown), examples of which include, but are not limited to, Windows®, OSX®, Unix®, Linux®, Windows Phone®, Android™, iOS®, WebOS™, and the like.

The memory elements 115 can include one or more physical memory devices such as, for example, local memory 125 and one or more bulk storage devices 130. Local memory 125 refers to random access memory or other non-persistent memory device(s) generally used during actual execution of the program code. The bulk storage device(s) 130 can be implemented as a HDD, SSD or other persistent data storage device. The processing system 105 also can include one or more cache memories (not shown) that provide temporary storage of at least some program code in order to reduce the number of times program code must be retrieved from the bulk storage device 130 during execution.

The processing system 105 can include one or more input/output (I/O) interfaces 140 via which one or more I/O devices 140 can be communicatively linked to the processor 110 via the system bus 120. The I/O interface(s) 140 can include graphical processing units, I/O controllers, and/or any other devices through which the user interface devices 145 can communicate with the processing system 105. Further, the I/O interface(s) 140 can include any of a variety of communication ports, for example USB ports, Thunderbolt® ports, IEEE-1494 (e.g., FireWire®) ports, PCI Express ports, serial ports, parallel ports, or any other suitable communication ports that support bi-directional communication. The I/O interface(s) 140 further can include one or more wireless communication transceivers. For example, such a wireless communication transceiver can communicate with the user interface devices 145 in accordance with a personal area network (PAN) communication protocol, such as BlueTooth® or Zigbee™, an infrared (IR) protocol, or the like. In another embodiment, the wireless communication transceiver also can communicate via WiFi™. Notwithstanding, the I/O interface(s) 140 can operate in accordance with any other suitable wireless communication protocols and the invention is not limited in this regard.

The I/O devices 140 can include a display, a touch screen, a keyboard, a keypad, a touch pad, a mouse and/or any other I/O devices. The I/O devices 140 can be internal to the processing system 105 or external to the processing system 105. By way of example, if the processing system 105 is a desktop computer, a keyboard, mouse and display can be external to the processing system 105. In another example, if the processing system 105 is a tablet computer, the processing system 105 can include an integrated touch screen.

In one embodiment, the processing system 105 can include a dock 150. As used herein, the term “dock” means a mechanical structure configured to mechanically attach to and structurally support (e.g., hold) a device and which includes at least one I/O port that communicatively links the device to a processor that is external to the device. In illustration, the dock 150 can be integrated to the chassis of the processing system 105. For example, a slot can be provided in which the wireless communication device may be inserted 155. In this regard, the dock 150 can be mechanically configured to attach to, and structurally support, a wireless communication device 155. Further, the dock 150 can include one or more I/O ports that connect to the wireless communication device 155 and communicatively link the wireless communication device 155 to the processor 110. The dock 150 can communicatively link the wireless communication device to the processor 110 via the I/O interface(s) 140 or directly through the system bus 120.

In another embodiment, the dock 150 dock can be integrated into a user interface device 145. For example, the dock can be integrated into the chassis of a display, the chassis of a keyboard or the chassis of a mouse. Again, the dock 150 can be mechanically configured to attach to, and structurally support, the wireless communication device 155, and the dock 150 can include one or more I/O ports that connect to the wireless communication device 155 and communicatively link the wireless communication device 155 to the processor 110.

In yet another embodiment, rather than using the dock 150, the wireless communication device 155 can be connected to the I/O interface 140 of the processing system 105. The wireless communication device 155 can be connected to the I/O interface via a wired connection (e.g., cable) or a via wireless communication link implemented in accordance with a suitable wireless communication protocol, for example any of those previously described with regard to the I/O interface 140.

The wireless communication device 155 can be a device that is suitably configured to operate independently of the processing system 105, though also suitably configured to operate with the processing system 105 as will be described herein. In other words, the wireless communication device 155 can be suitably configured to connect to a wireless communication network and operate as a stand-alone client when not communicatively linked to the processing system 105, or any other client side processing systems. As such, the wireless communication device 155 can include its own processor, memory, transceiver(s), I/O devices, etc. In illustration, the wireless communication device 155 can be a cellular communication device, such as mobile phone, a smart phone, a PDA, a tablet computer, or the like.

The processing system 105 further can include one or more communication adapters, for instance a first communication adapter 160 and a second communication adapter 165, communicatively linked to the processor 110. By way of example, the communication adapters 160, 165 can be connected to the I/O interface(s) 140, in which case respective communication ports are provided via the I/O interface(s) 140, or directly to the system bus 120, in which case respective communication ports (e.g., PCI or PCIe ports) are provided via the system bus 120.

The first and second communication adapters 160, 165 can enable the processing system 105 to become coupled to other systems, computer systems, remote printers, and/or remote storage devices through intervening private or public networks (e.g., the Internet), collectively referred to as a WAN 170.

In one arrangement, the first communication adapter 160 can be a wired network adapter, for example a network adapter configured to communicate in accordance with TCP/IP. Modems, cable modems, and Ethernet cards are examples of different types of network adapters that can be used, though the invention is not limited to these examples. In another arrangement, the first communication adapter 160 can be a wireless network adapter. In illustration, the first communication adapter 160 can include a transceiver configured to communicate data via IEEE 802 wireless communications, for example, 802.11 and 802.16 (WiMax), WPA, or WPA2. Still, the first communication adapter 160 can be configured to communicate in accordance with any suitable wired and/or wireless communication protocols and the invention is not limited in this regard.

The second communication adapter 165 can be configured to wirelessly communicate via a cellular communication network. In this regard, the second communication adapter 165 can include a transceiver configured to communicate in accordance with any suitable cellular communication protocols and/or specifications, examples of which include, but are not limited to, 4G, 4G, LTE, TDMA, CDMA, WCDMA, GSM, UMTS, GPRS, EUTRAN, UMB, OFDM, and the like.

As pictured in FIG. 1, the memory elements 115 can store a network communication application 175. The network communication application 175, being implemented in the form of executable program code, can be executed by the processing system 105 (e.g., by the processor 110), to perform the client-side methods, processes and functions described herein.

In operation, the processor 110 can execute the network communication application 175 to communicatively link the processing system 105 to a server 180 to establish two or more communication channels 182, 184, 186. In this regard, during execution of the network communication application 175, the processor 110 can communicate with the wireless communication device 155, the first communication adapter 160 and/or the second communication adapter 165 to simultaneously establish two or more communication channels 182-184 between the processing system 105 and the server 180. For example, the wireless communication device 155 can be communicatively linked to the server 180 to establish the communication channel 182, the first communication adapter 160 can be communicatively linked to the server 180 to establish the communication channel 184, and the second communication adapter 165 can be communicatively linked to the server 180 to establish the communication channel 186.

The information 190 can be data communicated in any suitable format, for example as packets or frames. Such data can represent multimedia content, audio content, video content, images, alphanumeric text, script, code, passwords, keys, or any other data that can be communicated via a communication network.

The processing system 105 can exchange the information 190 with the server 180 simultaneously over two or more of the communication channels 182-186. For example, the processing system 105 can exchange a first portion of the information 190-1 over the communication channel 182, exchange a second portion of the information 190-2 over the communication channel 184, and exchange a third portion of the information 190-4 over the communication channel 186. As used herein, the term “exchange information” means to send information and/or to receive information. In illustration, information can be downloaded from the server 180 to the processing system 105, or uploaded from the processing system 105 to the server. As used herein, the term “download” means to communicate information from a server or other source to a client (e.g., the processing system 105). As such, the term “download” encompasses not only transferring one or more files containing information, but also streaming information, such as multimedia content, to a client. As used herein, the term “upload” means to communicate information from a client to a server or other system. The term “upload” encompasses not only transferring one or more files containing information, but also streaming information, such as multimedia content, from a client.

The communication system 100 also can include an electronic commerce web server 192, which will be discussed herein in further detail.

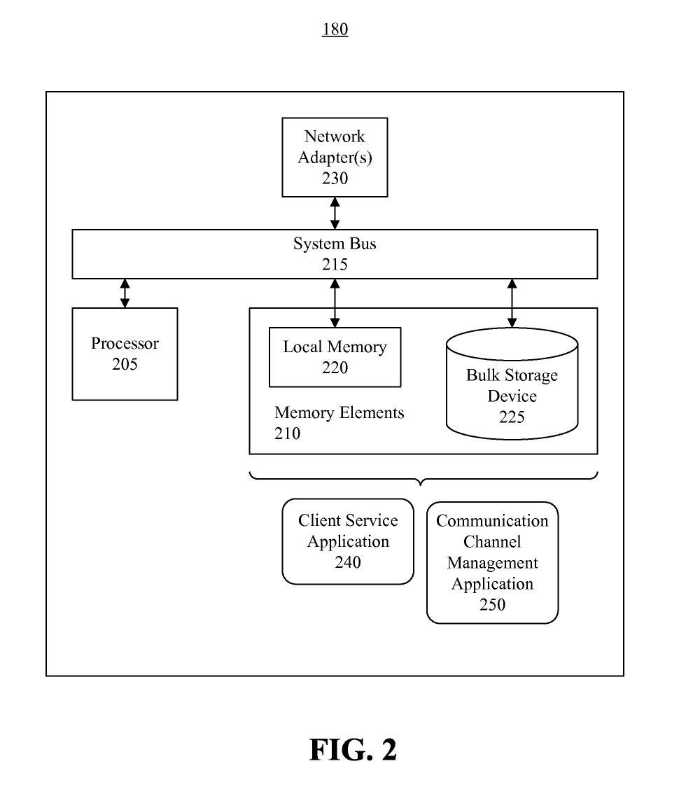

FIG. 2 is a block diagram illustrating a server 180 in accordance with one embodiment of the present invention. The server 180 can be a web server, an application server, or any other server with which the processing system 105 may establish a communication session and exchange information 190 with one or more clients. As used herein, the term “server” means a processing system that includes at least one processor. In this regard, the server 180 can include at least one processor 205 coupled to memory elements 210 through a system bus 215. As such, the server 180 can store program code within the memory elements 210. The processor 205 can execute the program code accessed from the memory elements 210 via the system bus 215. In one aspect, for example, the server 180 can be implemented as computer that is suitable for storing and/or executing program code. It should be appreciated, however, that the server 180 can be implemented in the form of any system comprising a processor and memory that is capable of performing the functions described within this specification.

The memory elements 210 can include one or more physical memory devices such as, for example, local memory 220 and one or more bulk storage devices 225. Local memory 220 refers to random access memory or other non-persistent memory device(s) generally used during actual execution of the program code. The bulk storage device(s) 225 can be implemented as a HDD, SSD or other persistent data storage device. The server 180 also can include one or more cache memories (not shown) that provide temporary storage of at least some program code in order to reduce the number of times program code must be retrieved from bulk storage device 225 during execution.

A network adapter 230 can be coupled to the server 180. The network adapter 230 can be coupled to the server 180 either directly or through intervening I/O interfaces. The network adapters 230 can enable the server 180 to become coupled to other systems, such as the processing system 105, through intervening private or public networks, such as the WAN 170. Modems, cable modems, and Ethernet cards are examples of different types of network adapters that can be used with the server 180.

As pictured in FIG. 2, the memory elements 210 can store a client service application 240. The client service application 240, being implemented in the form of executable program code, can be executed by the server 180 (e.g., by the processor 205), to perform the server-side methods, processes and functions related to providing information to one or more clients, as described herein. For example, the client service application 240 can be any application that provides information to clients. Examples of a web service application include, but are not limited to, a web site, a web page, a network accessible application, or the like.

Optionally, the memory elements 210 can store a communication channel management application 250. The management application 250, being implemented in the form of executable program code, also can be executed by the server 180 (e.g., by the processor 205), to perform the server-side methods, processes and functions related to channel management, as described herein. For example, the communication channel management application 250 can manage the exchange of information between the server 180 and the processing system 105 over a plurality of communication channels.

FIG. 2 also can represent the web server 192 depicted in FIG. 1, although in lieu of the client service application 240 and the communication channel management application 250, the memory elements 210 can store an electronic commerce application and/or web site (not shown) implemented in the form of executable program code. The electronic commerce application and/or web site can be executed by the web server 192 to perform the server-side methods, processes and functions related to electronic commerce, as described herein.

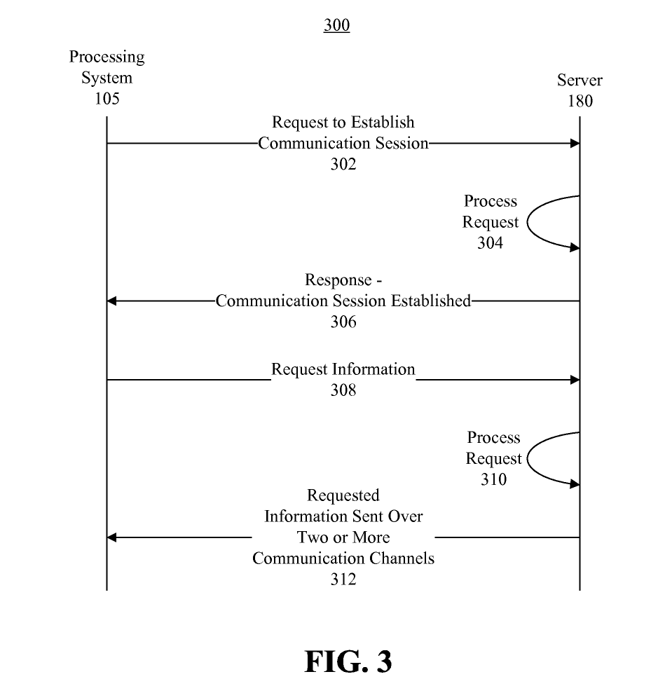

FIG. 3 is a flow diagram 300 representing exchange of information in accordance with one embodiment of the present invention. In this example, a communication session is established between the processing system 105 and the server 180 over a plurality of communication channels. The process described by the flow diagram 300 can be implemented when the server 180 is configured to support a particular communication session over a plurality of communication channels.

The description of the flow diagram 300 references various elements of FIG. 1, as appropriate. Further, the exchange of information can take place via the WAN 170 of FIG. 1.

At step 302, the processing system 105 can send to the server 180 a request to establish a communication session. Such request can be sent over a first communication channel. For example, the request can be communicated to the server 180 via the first communication adapter 160. In one embodiment, the request can identify each of the communication channels to be used to exchange information between the server 180 and the processing system 105. For example, in addition to providing a unique identifier (e.g., IP address, MAC address, or other unique identifier) of the first communication adapter 160, the request can identify a unique identifier corresponding to the wireless communication device 155 and/or a unique identifier corresponding to the second communication adapter 165.

At step 304, the server 180 can process the request to establish the requested communication session. The server can process not only the unique identifier of the first communication adapter 160, but also the unique identifier(s) for the wireless communication device 155 and/or second communication adapter 165. As such, the server 180 can establish a communication session in which information is communicated over a plurality of the respective communication channels 180-184 to be used. In this regard, the communication session can be established over a plurality of communication channels.

At step 306, the server 180 can send to the processing system 105 a response indicating that the communication session has been established. At step 308, the processing system 105 can send a request to the server 180 requesting information. The request can be sent over any of the communication channels 182-186 being used for the communication session.

At step 310, the server 180 can process the request. When processing the request, the server 180 can determine the total amount of data required to fulfill the request, and allocate different portions of the information 190-1, 190-2, 190-4 to different communication channels 182-186. When performing such allocation, the server 180 can determine the amount of bandwidth available over each communication channel 182-186, and allocate the information 190 to the different portions 190-1, 190-2, 190-4 accordingly.

By way of example, assume the communication session is established over the communication channels 182, 184. Further assume that the communication channel 184 provides twice as much bandwidth as the communication channel 182. The server can allocate the information 190 such that the portion of information 190-1 communicated over the communication channel 182 comprises one-third of the total amount of information 190, and the portion of information 190-2 communicated over the communication channel 184 comprises two-thirds of the total amount of information 190. Accordingly, the amount of time required to communicate the different portions 190-1, 190-2 of information 190 can be approximately equal. This is but one example, and the information 190 can be distributed to the different portions 190-1, 190-2 in any other suitable manner.

At step 312, the server 180 can send to the processing system 105 the requested information 190 over two or more communication channels 182-186. For instance, the server 180 can send a first portion of the information 190-1 over the communication channel 182, and send (e.g., download) a second portion of the information 190-2 over the communication channel 184. If additional communication channels are established, other portions of the information can be sent over such channels, in which case the information 190 can be apportioned accordingly. For example, a third portion of information 190-4 can be sent over the communication channel 186. The packets or frames in which the respective portions of information 190-1-190-3 are communicated can indicate to the processing system 105 information that indicates to the processing system 105 how the respective portions of information 190-1-190-3 relate, thus enabling the processing system 105 to combine and/or otherwise identify the respective portions of information 190-1-190-3 as being related.

In a similar manner, the processing system 105 can send information (e.g., upload the information) to the server 180. For example, the processing system 105 can send to the server 180 portions of information 190-1-190-3 over respective communication channels 182-186. The packets or frames in which the respective portions of information 190-1-190-3 are communicated can indicate to the server 180 information that indicates to the server 180 how the respective portions of information 190-1-190-3 relate, thus enabling the server 180 to combine and/or otherwise identify the respective portions of information 190-1-190-3 as being related.

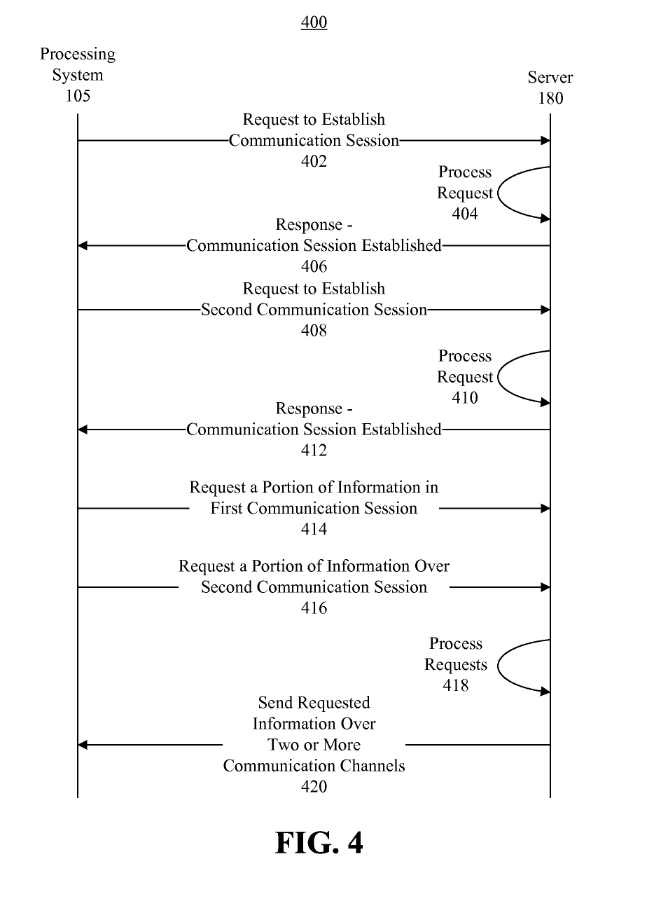

FIG. 4 is a flow diagram 400 representing exchange of information in accordance with another embodiment of the present invention. In this example, a respective communication session is established between the processing system 105 and the server 180 over each of a plurality of communication channels, and respective portions of information are exchanged in each of the communication sessions. The process described by the flow diagram 400 can be implemented when the server 180 is not configured to support a particular communication session over a plurality of communication channels, though this is not a requirement.

The description of the flow diagram 400 references various elements of FIG. 1, as appropriate. Further, the exchange of information can take place via the WAN 170 of FIG. 1.

At step 402, the processing system 105 can send to the server 180 a request to establish a first communication session. Such request can be sent over a first communication channel. For example, the request can be communicated to the server 180 via the first communication adapter 160. At step 404, the server 180 can process the request to establish the requested communication session. At step 406, the server 180 can send to the processing system 105 a response indicating that the first communication session has been established.

At step 408, the processing system 105 can send to the server 180 another request to establish a second communication session. Such request can be sent over a second communication channel. For example, the request can be communicated to the server 180 via the wireless communication device 155 or the second communication adapter 165. At step 410, the server 180 can process the request to establish the requested communication session. At step 412, the server 180 can send to the processing system 105 a response indicating that the second communication session has been established.

Additional requests, processing functions and responses (not shown) can be communicated between the processing system 105 and the server 180 to establish any number of additional communication sessions. For simplicity, the following example describes two communication sessions, but it will be understood by those skilled in the art than any number of communication sessions between the processing system 105 and the server 180 can be established, and respective portions of information 190 can be communicated between the processing system 105 and the server 180 over the respective communication sessions that are established.

The processing system 105 can send a plurality of requests to the server 180 requesting respective portions of information 190. By way of example, at step 414, the processing system 105 can send a first request for a first portion of information 190-1 over the communication channel 182 via the wireless communication device 155. At step 416 the processing system 105 can send a second request for a second portion of information 190-2 over the communication channel 184 via the first communication adapter 160. Optionally, the processing system 105 also can send additional requests for other portions of the information 190 over other communication channels, for example a third request for a third portion of information 190-4 over the communication channel 186 via the second communication adapter 165.

When sending the requests, the processing system 105 can estimate an approximate amount of data required to fulfill the requests. For example, assume the requested information 190 pertains to a particular multimedia presentation that is divided into parts. Prior to step 414, the processing system 105 can send a request (not shown) to the server 180 inquiring information about the multimedia presentation. If the server indicates that the multimedia presentation comprises two parts, the request generated at step 414 can request the first part and the request generated at step 416 can request the second part.

At step 418, the server 180 can process the requests received at steps 414 and 416 to identify the respective portions of the information 190-1-190-4. At step 420, the server 180 can respond to each of the requests received from the processing system 105 and send to the processing system 105 the respective portions of information 190-1-190-4 over the respective communication channels 182-186. Continuing the previous example, the server 180 can send a first part of the multimedia presentation over the communication channel 182 and a second part of the multimedia presentation over the communication channel 184. Again, the packets or frames in which the respective portions of information 190-1-190-3 are communicated can indicate to the processing system 105 information that indicates to the processing system 105 how the respective portions of information 190-1-190-3 relate, thus enabling the processing system 105 to combine and/or otherwise identify the respective portions of information 190-1-190-3 as being related.

In a similar manner, the processing system 105 can send information to the server 180. For example, the processing system 105 can send to the server 180 portions of information 190-1-190-3 over respective communication channels 182-186 in the respective communication sessions. The packets or frames in which the respective portions of information 190-1-190-3 are communicated can indicate to the server 180 information that indicates to the server 180 how the respective portions of information 190-1-190-3 relate, thus enabling the server 180 to combine and/or otherwise identify the respective portions of information 190-1-190-3 as being related.

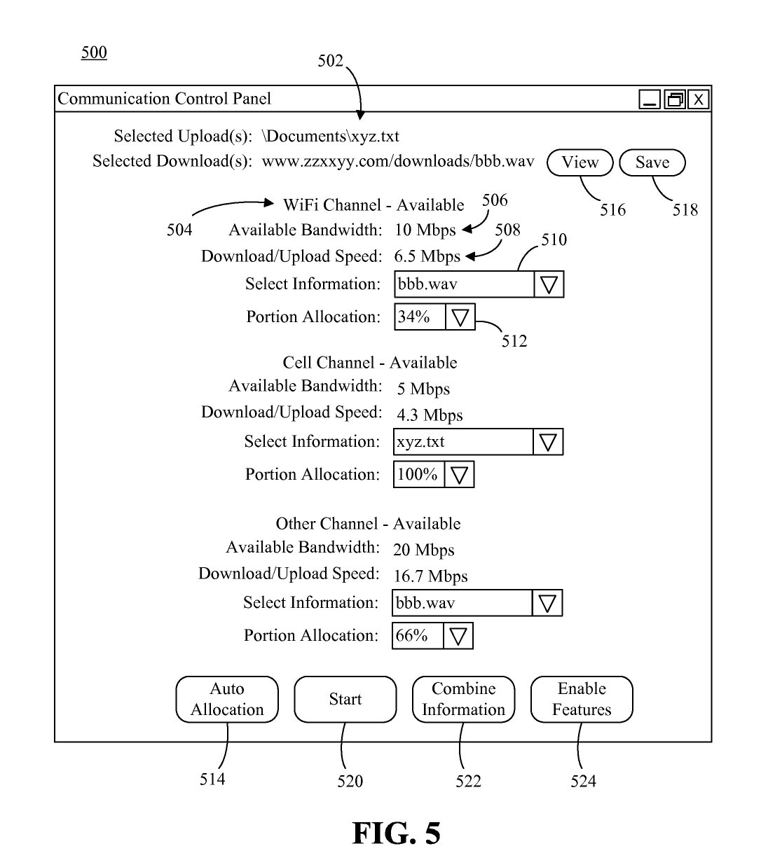

FIG. 5 depicts a view of a control panel 500 presented by a graphical user interface in accordance with one embodiment of the present invention. The control panel 500 can be generated by the processor 110 while executing the network communication application 175 depicted in FIG. 1. The control panel 500 can be presented on a display of the processing system 105, for example in response to a selection of information 502 to be downloaded to, or uploaded from, the processing system 105. In illustration, the control panel 500 can be presented, and each time information is selected to be downloaded or uploaded, such downloads/uploads can be indicated in the control panel 500. The control panel 500 can be minimized, maximized, or the size of the control panel 500 can be user adjusted in a manner conventional for the operating system of the processing system 105. As noted, the display can be integrated into a chassis of the processing system 105, or connected to the processing system 105 via a wired or wireless communication link, for example via the I/O interface 140.

The control panel 500 can indicate information 502 selected to be downloaded from, or uploaded to, the server 180. For example, the control panel 500 can indicate a URL corresponding to the information, a file name or a name of multimedia content, or the like. The control panel 500 further can indicate each of the communication channels that are available for the download(s) and/or upload(s), for example using identifiers, such as the identifier 504. Optionally, the control panel 500 further can indicate currently unavailable communication channels, and change their respective availability status when such communication channels become available.

For each communication channel, the control panel 500 can indicate an available bandwidth, measured download/upload speeds, or the like, for example using respective identifiers 506, 508. The measured download/upload speeds can be determined by an automatically performed speed test or determined based on data from previous downloads/uploads that were performed over the communication channels.

Further, for each communication channel, a field 510 can be provided to receive a user input selecting which information to download or upload over the communication channel. In addition, for each communication channel, a field 512 can be provided to receive a user input selecting which portion of the information is to download or upload over the communication channel. The fields 510, 512 can be a combo boxes, pull down menus, or any other suitable types of fields.

In illustration, assume that a file “bbb.wav” is to be downloaded over a WiFi channel and another communication channel. The user can allocate a first portion of the file to be downloaded over the WiFi channel, and a second portion of the information over the other communication channel. Further, a user selectable control 514, such as a button, icon or the like, can be provided to initiate automatic apportioning of the information across the communication channels selected to download or upload the information. When a user selects the control 514, the processing system can automatically apportion the information. Such apportion can be based on available bandwidth on each communication channel, download/upload speeds measured on the respective communication channels, or based on any other suitable criteria. To obtain data relating to the download upload speeds, the processing system can automatically perform a speed test, or obtain the data from previous downloads/uploads that were performed over the communication channels.

Further, for each download, the control panel 500 can present controls 516, 518 to receive a user input selecting whether to view and/or save the downloaded information. If the user selects the “view” control 516, presentation of the information can commence when download of the information begins. If the user selects the “save” control 518, the information can be saved to the memory of the processing system 105 (e.g., to the bulk storage device 130), or saved to another location. Further, in response to the user selecting the “save” control 518, a pop-up window can be presented to the user via which the user can select the directory in which to save the information.

The control panel 500 further can provide a user selectable “Start” control 520 that initiates download or upload of the selected information when selected by the user. Optionally, an individual “Start” control 520 can be provided for each of the respective download/uploads, or for each of the respective communication channels. When the downloads/uploads are complete, an indicator of such can be presented to the user. Further, one or more progress bars (not shown) can be presented in the control panel 500 to represent the progress of each download/upload.

A user selectable “combine information” control 522 can be provided in the control panel 500. User selection of the “combine information” control 522 can indicate to the processing system 105 that information downloaded over at least two channels is to be combined. By way of example, a file “bbb.wav” can be downloaded over two communication channels. When the “combine information” control 522 is selected, such information can be automatically combined into a single file. In this regard, each respective portion of the information can include one or more identifiers indicating the order in which the portions of the information are to be combined.

In one aspect, a communication service provider and/or a vendor of the processing system 105 (e.g., the hardware manufacturer) can charge a fee to the user to use the feature of simultaneously uploading and/or downloading information over a plurality of communication channels. By way example, when the user chooses the “Start” control 520 to initiate download and/or upload of information, or when the user selects a plurality of communication channels to use for downloading and/or uploading the information, a window, such as a pop-up window or other graphical user interface object, can be presented over the control panel 500.

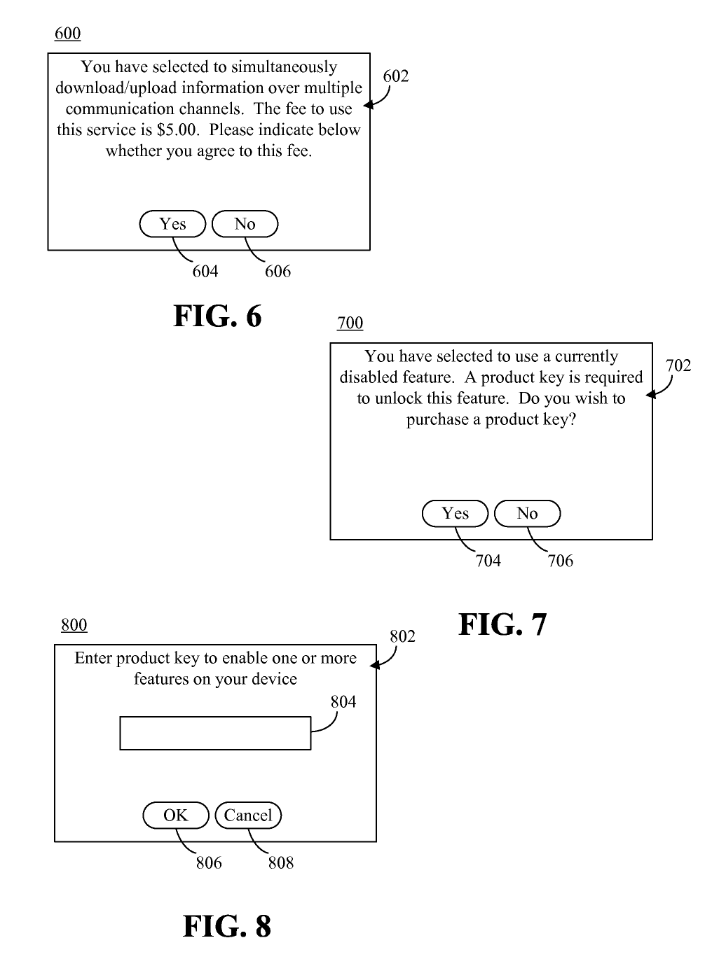

An example of such a window 600 is presented in FIG. 6. The window 600 can provide contextual information 602 indicating that a fee will be incurred to use the multi-channel communication feature. The window 600 further can provide user selectable controls 604, 606 to receive a user input indicating whether the user agrees to the terms indicated in the contextual information 602. If the user does not agree, and selects the “No” control 606, the multi-channel communication feature can remain deactivated. In this regard, the multi-channel communication feature can be deactivated by default. If the user agrees by selecting the “Yes” control 604, the multi-channel network communication feature can be enabled and the user can upload and/or download the information simultaneously over a plurality of the communication channels.

For example, an event can be generated by the network communication application 175. The event can trigger communication by the processing system 105 via one or more of the wireless communication device 155, the first communication adapter 160 and/or the second communication adapter 165 to be enabled. In illustration, assume that the first communication adapter 160 is enabled and ready to communicate over the communication channel 184. If the user desires to use a one or more additional communication channels 182, 186 via the second communication adapter 165 and/or the wireless communication device 155, the event can trigger the processing system 105 to enable network communications over the additional communication channel(s) 182, 186.

Further, a transaction notification can be generated to apply the fee to an account associated with the processing system 105. The transaction notification can be generated by the processing system 105, or the electronic commerce web server 192 to which the processing system 105 is communicatively linked.

In one embodiment, a communication service provider and/or a vendor of the processing system 105 (e.g., the hardware manufacturer) can charge a fee to the user to activate a currently disabled communication adapter, such as the second communication adapter 165, or to activate network communication via the wireless communication device 155. By way example, when the user chooses the “Start” control 520 to initiate download and/or upload of information, or when the user selects a plurality of communication channels to use for downloading and/or uploading the information, a window, such as a pop-up window or other graphical user interface object, can be presented over the control panel 500.

An example of such a window 700 is presented in FIG. 7. The window 700 can provide contextual information 702 indicating that an identifier, such as a product key or feature key, is required to activate the second communication adapter 165 or to enable network communication via the wireless communication device 155. The window 600 further can provide user selectable controls 704, 706 to receive a user input indicating whether the user wishes to purchase such an identifier. If the user does not agree, and selects the “No” control 706, the second communication adapter 165 or network communication via the wireless communication device 155 can remain deactivated. In this regard, such features can be deactivated by default.

If the user agrees by selecting the “Yes” control 704, a client session can be automatically established between the processing system 105 and the electronic commerce web server 192 to allow the user to purchase the identifier via an electronic commerce transaction. For example, selecting the “Yes” control 704 can launch a web browser on the processing system 105 and the appropriate URL of the web site on the web server 192 where the identifier can be purchased can be automatically entered into the web browser's address field. It should be noted that the window 700 is required to initiate the transaction to obtain the identifier. For example, the user can access the appropriate website via a web browser and purchase the identifier.

Upon completion of the commercial transaction, the identifier can be provided to the user via the website on which the transaction was conducted, e-mailed to the user, or sent to the user via postal delivery. To enter the identifier into the processing system, the user can select an “enable features” user selectable control 524 (FIG. 5) in the control panel 500, or select a suitable menu item from a drop-down menu, to activate an identifier entry window 800, shown in FIG. 8. The window 800 can provide contextual information 802 indicating that an identifier, such as a product key, can be entered to enable one or more features on the processing system 105. A field can be provided in which the identifier can be entered by the user. After entering the identifier, the user can select an “OK” user selectable control to save the identifier in the processing system 105 and enable the desired feature (e.g., enable the second communication adapter 165 and/or enable network communication via the wireless communication device 155). The identifier can be stored in the network communication application 175, stored in firmware (e.g., bios) of the processing system, or stored in any other suitable manner. The feature(s) can be enabled permanently on the processing system 105, or temporarily enabled. A “Cancel” user selectable control can be selected by the user to cancel the identifier entry process and close the window 800.

In another arrangement, rather than the window 800 being presented, the identifier can be automatically downloaded from the web server 192 to the processing system 105 and automatically entered into the processing system 105 to enable the desired feature(s). Again, the identifier can be stored in the network communication application 175, stored in firmware (e.g., bios) of the processing system, or stored in any other suitable manner.

The web server 192 can automatically generate the identifier, or receive the automatically generated identifier from another server. The identifier can include alphanumeric text and/or symbols, or code, and can be generated specifically for the processing system 105. For example, the identifier can include a string of characters that correspond to that particular processing system 105, and thus cannot be re-used on another processing system.

At this point it should be noted that the control panel 500 and windows 600-800 depicted in FIGS. 5-8 are mere examples representing a manner in which the user can interact with the processing system 105. In another embodiment, rather than presenting the control panel 500 and windows 600-800 via a graphical user interface, the features represented therein can be audibly presented to the user as audible menu items, for example using text-to-speech syntheses, which may be implemented using a suitable application executing on the processing system 105. Further, the user can enter user inputs, for example to make menu selections, using spoken utterances. Speech recognition also can be implemented using a suitable application executing on the processing system 105.

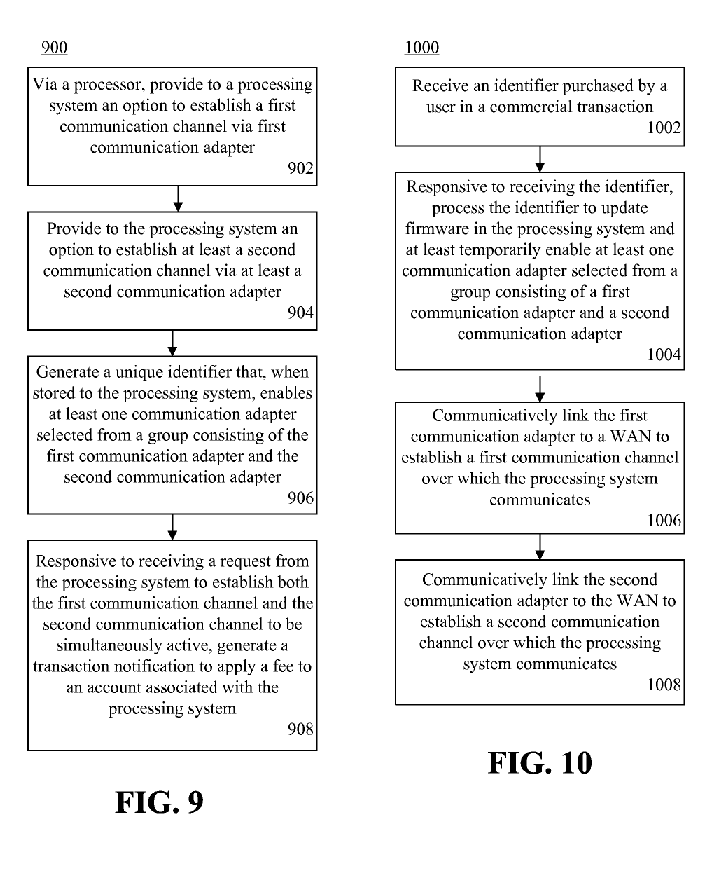

FIG. 9 is a flow chart illustrating a method 900 of increasing communication bandwidth for a processing in accordance with one embodiment of the present invention. The method 900 can be implemented by the server 180 of FIG. 1.

At step 902, via a processor, a processing system can be provided an option to establish a first communication channel via first communication adapter. At step 904, the processing system can be provided an option to establish at least a second communication channel via at least a second communication adapter. For example, the processing system can be provided an option to establish the second communication channel via a cellular telephone communicatively linked to the processing system, or a communication adapter linked to the processing system.

At step 906, a unique identifier can be generated. The unique identifier can, when stored to the processing system, enable at least one communication adapter selected from a group consisting of the first communication adapter and the second communication adapter. At step 908, responsive to receiving a request from the processing system to establish both the first communication channel and the second communication channel to be simultaneously active, transaction notification can be generated to apply a fee to an account associated with the processing system

FIG. 10 is a flow chart illustrating a method 1000 of increasing communication bandwidth for a processing in accordance with one embodiment of the present invention. The method 1000 can be implemented by the processing system 105 of FIG. 1.

At step 1002, an identifier purchased by a user in a commercial transaction can be received. At step 1004, responsive to receiving the identifier, the identifier can be processed to update firmware in the processing system and at least temporarily enable at least one communication adapter selected from a group consisting of a first communication adapter and a second communication adapter. In one arrangement, the communication adapter can be permanently enabled. At step 1006, the first communication adapter can be communicatively linked to a WAN to establish a first communication channel over which the processing system communicates. At step 1008, the second communication adapter can be communicatively linked to the WAN to establish a second communication channel over which the processing system communicates.

Like numbers have been used to refer to the same items throughout this specification. The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, a “user” is a person (i.e., a human being).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of providing a plurality of communication channels for use by a processing system, the method comprising:
via a processor, providing to the processing system an option to establish a first communication channel via first communication adapter;
providing to the processing system an option to establish at least a second communication channel via at least a second communication adapter; and
responsive to receiving a request from the processing system to establish both the first communication channel and the second communication channel to be simultaneously active, generating a transaction notification to apply a fee to an account associated with the processing system.

2. The method of claim 1, wherein providing to the processing system the option to establish the second communication channel via at least the second communication adapter comprises:
providing to the processing system an option to establish the second communication channel via a cellular telephone communicatively linked to the processing system.

3. The method of claim 1, wherein providing to the processing system the option to establish the second communication channel via at least the second communication adapter comprises:
providing to the processing system an option to establish the second communication channel via a communication adapter linked to the processing system.

4. The method of claim 1, further comprising:
generating a unique identifier that, when stored to the processing system, enables at least one communication adapter selected from a group consisting of the first communication adapter and the second communication adapter.

5. The method of claim 1, wherein receiving the request from the processing system to simultaneously establish the first and second communication channels comprises:
receiving the request from a control panel presented to a user.

6. A method of providing a plurality of communication channels for use by a processing system, the method comprising:
receiving an identifier purchased by a user in a commercial transaction; and
responsive to receiving the identifier, at least temporarily enabling at least one communication adapter selected from a group consisting of a first communication adapter and a second communication adapter.

7. The method of claim 6, further comprising
communicatively linking the first communication adapter to a wide area network (WAN) to establish a first communication channel over which the processing system communicates; and
communicatively linking the second communication adapter to the WAN to establish a second communication channel over which the processing system communicates;
simultaneously communicating information between the processing system and at least one server over both the first communication channel and the second communication channel.

8. The method of claim 6, wherein at least temporarily enabling at least one communication adapter selected from a group consisting of a first communication adapter and a second communication adapter comprises permanently enabling at least one communication adapter selected from a group consisting of a first communication adapter and a second communication adapter.

9. A method of providing a plurality of communication channels for use by a processing system, the method comprising:
receiving an identifier purchased by a user in a commercial transaction;
responsive to receiving the identifier, processing the identifier to update firmware in the processing system and at least temporarily enabling at least one communication adapter selected from a group consisting of a first communication adapter and a second communication adapter.

10. A server comprising:
a processor is configured to:
provide to a processing system an option to establish a first communication channel via first communication adapter;
provide to the processing system an option to establish at least a second communication channel via at least a second communication adapter; and
responsive to receiving a request from the processing system to establish both the first communication channel and the second communication channel to be simultaneously active, generate a transaction notification to apply a fee to an account associated with the processing system.

11. The server of claim 10, wherein the processor further is configured to:
provide to the processing system an option to establish the second communication channel via a cellular telephone communicatively linked to the processing system.

12. The server of claim 10, wherein the processor further is configured to:
provide to the processing system an option to establish the second communication channel via a communication adapter linked to the processing system.

13. The server of claim 10, wherein the processor further is configure to:
generate a unique identifier that, when stored to the processing system, enables at least one communication adapter selected from a group consisting of the first communication adapter and the second communication adapter.

14. The server of claim 10, wherein receiving the request from the processing system to simultaneously establish the first and second communication channels comprises:
receiving the request from a control panel presented to a user.

15. A processing system comprising:
a processor is configured to:
receive an identifier purchased by a user in a commercial transaction; and
responsive to receiving the identifier, at least temporarily enable at least one communication adapter selected from a group consisting of a first communication adapter and a second communication adapter.

16. The processing system of claim 15, wherein the processor further is configure to:
communicatively link the first communication adapter to a wide area network (WAN) to establish a first communication channel over which the processing system communicates; and
communicatively link the second communication adapter to the WAN to establish a second communication channel over which the processing system communicates;
simultaneously communicate information between the processing system and at least one server over both the first communication channel and the second communication channel.

17. The processing system of claim 15, wherein the processor is configured to permanently enable at least one communication adapter selected from a group consisting of a first communication adapter and a second communication adapter.

18. A processing system comprising:
a processor is configured to:
receive an identifier purchased by a user in a commercial transaction;
responsive to receiving the identifier, process the identifier to update firmware in the processing system and at least temporarily enable at least one communication adapter selected from a group consisting of a first communication adapter and a second communication adapter.

19. A computer program product for increasing communication bandwidth for a processing system, the computer program product comprising:
a computer-readable storage medium having computer-readable program code embodied therewith, the computer-readable program code comprising:
computer-readable program code configured to provide to a processing system an option to establish a first communication channel via first communication adapter;
computer-readable program code configured to provide to the processing system an option to establish at least a second communication channel via at least a second communication adapter; and
computer-readable program code configured to, responsive to receiving a request from the processing system to establish both the first communication channel and the second communication channel to be simultaneously active, generate a transaction notification to apply a fee to an account associated with the processing system.

20. The computer program product of claim 19, the computer-readable program code further comprising:
computer-readable program code configured to provide to the processing system an option to establish the second communication channel via a cellular telephone communicatively linked to the processing system.

21. The computer program product of claim 19, the computer-readable program code further comprising:
computer-readable program code configured to provide to the processing system an option to establish the second communication channel via a communication adapter linked to the processing system.

22. The computer program product of claim 19, the computer-readable program code further comprising:
computer-readable program code configured to generate a unique identifier that, when stored to the processing system, enables at least one communication adapter selected from a group consisting of the first communication adapter and the second communication adapter.

23. The computer program product of claim 19, wherein the computer-readable program code configured to receive the request from the processing system to simultaneously establish the first and second communication channels comprises:
computer-readable program code configured to receive the request from a control panel presented to a user.

24. A computer program product for increasing communication bandwidth for a processing system, the computer program product comprising:
a computer-readable storage medium having computer-readable program code embodied therewith, the computer-readable program code comprising:
computer-readable program code configured to receive an identifier purchased by a user in a commercial transaction; and
computer-readable program code configured to, responsive to receiving the identifier, at least temporarily enable at least one communication adapter selected from a group consisting of a first communication adapter and a second communication adapter.

25. The computer program product of claim 24, the computer-readable program code further comprising:
computer-readable program code configured to communicatively link the first communication adapter to a wide area network (WAN) to establish a first communication channel over which the processing system communicates; and
computer-readable program code configured to communicatively link the second communication adapter to the WAN to establish a second communication channel over which the processing system communicates;
computer-readable program code configured to simultaneously communicate information between the processing system and at least one server over both the first communication channel and the second communication channel.

26. The computer program product of claim 24, the computer-readable program code further comprising:
computer-readable program code configured to permanently enable at least one communication adapter selected from a group consisting of a first communication adapter and a second communication adapter.

27. A computer program product for increasing communication bandwidth for a processing system, the computer program product comprising:
a computer-readable storage medium having computer-readable program code embodied therewith, the computer-readable program code comprising:
computer-readable program code configured to receive an identifier purchased by a user in a commercial transaction;
computer-readable program code configured to, responsive to receiving the identifier, process the identifier to update firmware in the processing system and at least temporarily enable at least one communication adapter selected from a group consisting of a first communication adapter and a second communication adapter.
